(19) United States
(12) Patent Application Publication
(10) Pub. No.: US 2006/0023900 A1
(43) Pub. Date: Feb. 2, 2006

(54) Method and apparatus for priority based audio mixing

(76) Inventors: George W. Erhart, Pataskala, OH (US); Valentine C. Matula, Granville, OH (US); David Skiba, Columbus, OH (US)

Correspondence Address: Ryan, Mason & Lewis, LLP, Suite 205, 1300 Post Road, Fairfield, CT, 06824, US

(21) Appl. No.: 10/900,560

(22) Filed: Jul. 28, 2004

(51) Int. Cl. H04B 1/00; G06F 17/00

(52) U.S. Cl. 381/119; 700/94

(57) ABSTRACT

Methods and apparatus are disclosed for priority based audio mixing. At least one audio characteristic of one or more audio streams is modified to convey a relative priority of the audio streams, prior to mixing the audio streams. The adjusted audio characteristic may be, for example, a volume, pitch or speed of one or more audio streams. The relative priority information may be based, for example, on an analysis of the content of one or more of the audio streams. In further variations, the priority is based on one or more characteristics of a speaker or application associated with an audio stream.

### FIELD OF THE INVENTION

The present invention relates generally to the mixing of audio streams and, more particularly, to the mixing of audio streams based on a priority of each stream.

### BACKGROUND OF THE INVENTION

In many audio processing systems, multiple audio sources must often be played to a single destination at the same time. For example, an audio conferencing system may have to process a number of audio streams at the same time, each associated with a different participant. The conferencing system must either select a single audio stream to present or mix a number of the digital audio streams together in some manner. A single stream can be selected, for example, based on the stream that is believed to be most relevant to the current context of the application. The selected stream generally changes as the relative importance of each stream changes over time.

When a number of digital audio streams are mixed together, however, it is often difficult for a listener to distinguish the various streams, or to focus on the most important information. A need therefore exists for an improved method and apparatus for mixing a plurality of audio streams. A further need exists for a method and apparatus for mixing a plurality of audio streams that allows a user to more easily focus on the most important information. Yet another need exists for a method and apparatus for mixing one or more higher priority audio streams with one or more lower priority audio streams.

### SUMMARY OF THE INVENTION

Generally, methods and apparatus are provided for priority based audio mixing. The present invention modifies at least one audio characteristic of one or more audio streams to convey a relative priority of the audio streams, prior to mixing audio streams. The adjusted audio characteristic may be, for example, a volume, pitch or speed of one or more audio streams. The relative priority information may be based, for example, on an analysis of the content of one or more of the audio streams. In further variations, the priority is based on one or more characteristics of a speaker or application associated with an audio stream.

In one application, the present invention allows high priority announcements or instructions to be provided to one or more participants in a call. For example, in a call center environment, the invention allows important information to be provided to the caller or the call center agent.

A more complete understanding of the present invention, as well as further features and advantages of the present invention, will be obtained by reference to the following detailed description and drawings.

### BRIEF DESCRIPTION OF THE DRAWINGS

FIG. 1 is a schematic block diagram of a priority based audio mixer (PBAM) incorporating features of the present invention; and

FIG. 2 is a schematic block diagram of a call control/mixing server that may be used in a call center environment and incorporates features of the present invention.

### DETAILED DESCRIPTION

The present invention recognizes that humans can distinguish individual audio streams from a mixed audio source based on different audio characteristics. Thus, the present invention conveys audio priority to a listener by modifying one or more characteristics of the audio signals, such as volume, pitch or speed.

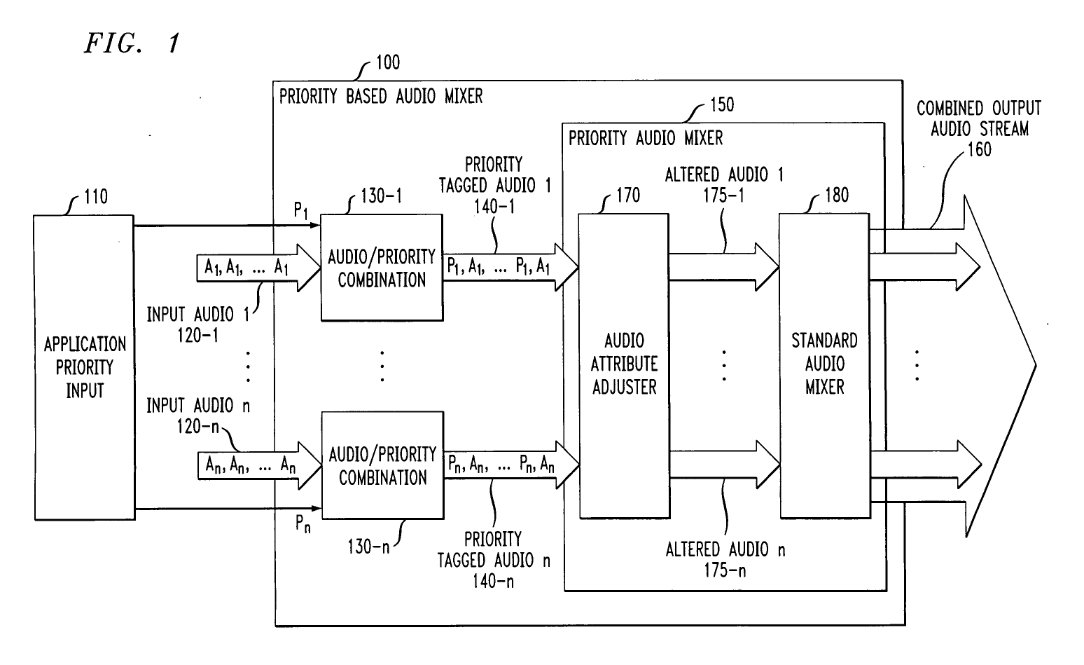

FIG. 1 is a schematic block diagram of a priority based audio mixer (PBAM) 100 incorporating features of the present invention. As shown in FIG. 1, the disclosed priority based audio mixer 100 mixes multiple input audio streams 120-1 through 120-n into one combined output audio stream 160 based on a corresponding priority P₁ through Pₙ given to each input stream 120-1 through 120-n. Each input audio stream 120-1 through 120-n is comprised of a stream of audio packets A₁ through Aₙ, respectively.

As indicated above, the present invention conveys audio priority to a listener by modifying one or more characteristics of the audio signals, such as volume, pitch or speed. In an exemplary embodiment of the invention, the volume is adjusted to convey audio priority. Thus, in the illustrative embodiment, higher priority streams are mixed at a higher volume, relative to lower priority streams. For example, the highest priority stream can be played at an amplified volume and the remaining audio stream can be played at a default volume level. The result is a mixed audio stream 160 containing louder and softer streams. The resulting effect is a mixed stream that contains some whisper items and one or more additional items that are spoken loudly. The listener is able to keep track of the lower volume background items while maintaining a main focus on the louder audio stream(s). In addition to modification of the volume, changes in pitch, speed, and/or other audio characteristics could be used to convey the same priority information, as would be apparent to a person of ordinary skill in the art.

The priority based audio mixer 100 combines multiple input audio streams 120 into a single audio stream 160 using a priority P₁ through Pₙ assigned to each stream. In one implementation, each input audio packet A₁ through Aₙ has a priority associated with it that is obtained from an application priority input 110. Thus, each audio stream has an associated numbered priority. The priority may be set, for example, when the stream starts, and can be changed at any time by directing the priority based audio mixer 100 to change the priority for one or more streams. The input audio streams 120-1 through 120-n is tagged with the corresponding the assigned priority P₁ through Pₙ by a corresponding audio/priority combination stage 130-1 through 130-n to produce priority tagged audio streams 140-1 through 140-n. In the exemplary embodiment, the audio/priority combination stage 130-1 through 130-n takes the continuous audio streams and combine them with the corresponding priority information, for priority-based modification by the mixer 150 (where the resulting output streams 140-1 through 140-n are a packet form of each audio stream with the priority level attached to each packet).

The priority P₁ through Pₙ associated with each audio stream may be, for example, a numeric indicator of the priority of the associated stream. The priority number may be a relative number, based on the priority of the other streams. For example, if mixing a stream with priority values of 10, 2 and 1, an audio output is generated where the stream having a priority of 10 is the main foreground stream (loudest) and the streams having priorities of 2 and 1 are background streams (lower volume). The priority P₁ through Pₙ may be based, for example, on an analysis of the current content of each audio stream, characteristics of the speaker or application, such as job title or some other ranking, or a subscription service where a user may have paid a premium to have his or her audio prioritized. In one implementation, a predefined number of high priority audio streams are played at an amplified volume level and the remaining audio streams are played at a default volume level.

While the embodiment shown in FIG. 1 processes the N audio streams in parallel, it is noted that a variation of the present invention would allow for serial processing of the N audio streams, as would be apparent to a person of ordinary skill in the art.

The priority audio mixer 150 includes an audio attribute adjuster 170 and a standard audio mixer 180. The audio attribute adjuster 170 performs the priority-based modification to the audio stream to generate an altered audio stream 175-1 through 175-n (where, for example, the resulting output is the appropriate volume adjusted audio stream). The standard audio mixer 180 may be implemented using any commercially available audio mixer, such as, for example, the Simple Direct Media Layer (SDL) mixer, described in http://www.libsdl.org/projects/SDL_mixer/, incorporated by reference herein. If there is only one input stream, then the mixer 180 behaves as a pass-through filter and produces an output audio stream 160 that matches the input audio stream. For multiple streams, the mixer 150 orders the streams in priority order and the audio portion is scaled accordingly. The resulting audio packets are scaled to achieve the same proportions as the packet priorities. The scaled audio packets are then combined to produce the resulting combined audio output stream 160. This procedure can be performed as each set of packets arrive to the mixer.

The priorities are specified on a scale that is application dependent. The important information is the relationship of the priorities of the streams being mixed. The final output volume is specified in decibels. The highest (foreground) audio stream would be adjusted to have an average volume equal to the specified output volume. Other lower priority audio streams would be adjusted to a lower decibel level that was equivalent to the ratio of priority of the highest priority and the lower priority stream (db=max db*(highest priority/lower priority)).

The audio packets may vary in size based, for example, on audio quality and bit rate. A typical size would be 100 millisecond packets. As the audio packets are received, a volume transformation is then made to the audio stream by the corresponding audio/priority combination stage 170. Based on the current stream priority, the volume of the stream is either increased for higher priorities or maintained or decreased for lower priorities. The transformation is made to the audio packet currently being processed. Once all input audio packets are processed, the streams are mixed together by the mixer 180 to form the output stream 160. The combined output stream 160 is the output as the result of the priority based mix. This operation continues while there is input audio to be processed. The combined output 160 could be sent to any party of a multiparty connection.

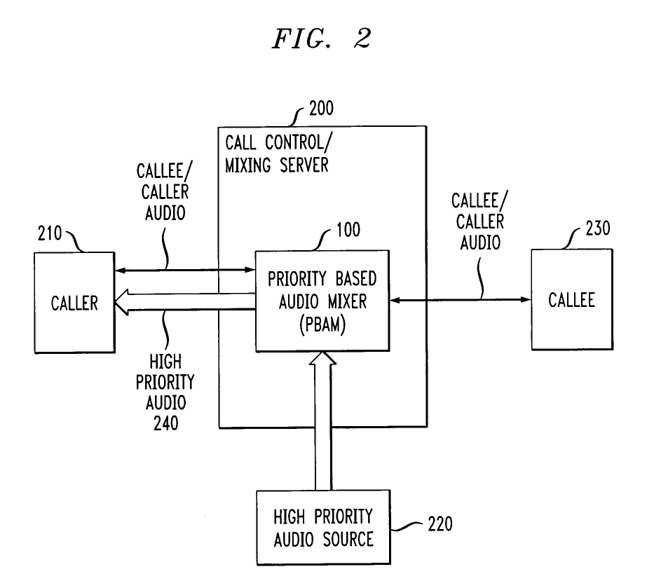

FIG. 2 is a schematic block diagram of a call control/mixing server 200 that may be used in a call center environment and incorporates features of the present invention. As shown in FIG. 2, the call control/mixing server 200 includes the priority based audio mixer 100 of FIG. 1. The priority based audio mixer 100 is used in the embodiment of FIG. 2 to mix high priority audio 220 with the callee audio from the callee 230 that is played to the caller 210. For example, the high priority audio 220 may comprise an announcement, such as an emergency announcement, additional instructions or feedback, that is provided to the caller 210 with the callee/caller audio stream. The high priority audio 220 may be obtained from a database of prerecorded messages or from a human agent. A priority based audio mixer 100 could be used to mix audio for any of the endpoints in the call.

In another variation, the priority based audio mixer 100 can be used, for example, by a supervisor, to convey instructions to call center agents while the agent is listening to an incoming call.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for mixing a plurality of audio streams, comprising:
adjusting an audio characteristic of one or more of said plurality of audio streams based on a priority of at least one of said plurality of audio streams; and
mixing said plurality of audio streams.

2. The method of claim 1, wherein each of said plurality of audio streams has an associated priority.

3. The method of claim 2, wherein said associated priority is a numeric indicator of the priority of the associated stream.

4. The method of claim 1, wherein said adjusted audio characteristic is a volume of said one or more of said plurality of audio streams.

5. The method of claim 1, wherein said adjusted audio characteristic is a pitch of said one or more of said plurality of audio streams.

6. The method of claim 1, wherein said adjusted audio characteristic is a speed of said one or more of said plurality of audio streams.

7. The method of claim 1, wherein said priority is based on an analysis of the content of one or more of said audio streams.

8. The method of claim 1, wherein said priority is based on characteristics of a speaker associated with an audio stream.

9. The method of claim 1, wherein said priority is based on characteristics of an application associated with an audio stream.

10. The method of claim 1, wherein said priority is based on a subscription service that establishes a priority of one or more of said audio streams.

11. The method of claim 1, wherein a high priority is assigned to one or more instructions provided to one or more participants in a call.

12. The method of claim 1, wherein a high priority is assigned to an emergency announcement for one or more participants in a call.

13. An audio mixer that mixes a plurality of audio streams, comprising:
one or more inputs for receiving said plurality of audio streams;
at least one audio attribute adjuster for adjusting one or more audio characteristics of one or more of said plurality of audio streams to convey a relative priority of said audio streams; and
a mixer to mix said plurality of audio streams.

14. The audio mixer of claim 13, wherein each of said plurality of audio streams has an associated priority.

15. The audio mixer of claim 14, wherein said associated priority is a numeric indicator of the priority of the associated stream.

16. The audio mixer of claim 13, wherein said adjusted audio characteristic is a volume of said one or more of said plurality of audio streams.

17. The audio mixer of claim 13, wherein said adjusted audio characteristic is a pitch of said one or more of said plurality of audio streams.

18. The audio mixer of claim 13, wherein said adjusted audio characteristic is a speed of said one or more of said plurality of audio streams.

19. The audio mixer of claim 13, wherein said priority is based on an analysis of the content of one or more of said audio streams.

20. The audio mixer of claim 13, wherein said priority is based on characteristics of a speaker associated with an audio stream.

21. The audio mixer of claim 13, wherein said priority is based on characteristics of an application associated with an audio stream.

22. The audio mixer of claim 13, wherein said priority is based on a subscription service that establishes a priority of one or more of said audio streams.

23. The audio mixer of claim 13, wherein a high priority is assigned to one or more instructions provided to one or more participants in a call.

24. The audio mixer of claim 13, wherein a high priority is assigned to an emergency announcement for one or more participants in a call.

25. An article of manufacture for mixing a plurality of audio streams, comprising a machine readable medium containing one or more programs which when executed implement the steps of:
adjusting an audio characteristic of one or more of said plurality of audio streams based on a priority of at least one of said plurality of audio streams; and
mixing said plurality of audio streams.
